(19) United States
(12) Patent Application Publication
(10) Pub. No.: US 2025/0014815 A1
(43) Pub. Date: Jan. 9, 2025

(54) METHOD FOR MANUFACTURING MAGNETIC CORE AND METHOD FOR MANUFACTURING COIL COMPONENT

(71) Applicant: Murata Manufacturing Co., Ltd., Kyoto-fu (JP)

(72) Inventor: Hiroshi MARUSAWA, Nagaokakyo-shi (JP)

(73) Assignee: Murata Manufacturing Co., Ltd., Kyoto-fu (JP)

(21) Appl. No.: 18/891,392

(22) Filed: Sep. 20, 2024

Related U.S. Application Data
(63) Continuation of application No. PCT/JP2023/002954, filed on Jan. 31, 2023.

(30) Foreign Application Priority Data
Mar. 31, 2022 (JP) 2022-059956

(51) Int. Cl. H01F 41/02; B22F 1/08; B22F 1/12; B22F 1/16; B22F 10/28; B33Y 10/00; B33Y 70/10; H01F 1/147

(52) U.S. Cl. CPC H01F 41/0246; B22F 1/08; B22F 1/12; B22F 1/16; B22F 10/28; B33Y 10/00; B33Y 70/10; H01F 1/147; B22F 2301/35; B22F 2302/256; B22F 2302/45; B22F 2304/10; B22F 2998/10; B22F 2999/00

(57) ABSTRACT

A method for manufacturing a magnetic core includes a step of melting a raw material powder, comprising a soft magnetic metal powder and an agglomeration inhibitor, using laser irradiation or electron beam sweeping, and then solidifying the melt, thereby forming a three-dimensional magnetic composite.

### CROSS-REFERENCE TO RELATED APPLICATIONS

This application claims benefit of priority to International Patent Application No. PCT/JP2023/002954, filed Jan. 31, 2023, and to Japanese Patent Application No. 2022-059956, filed Mar. 31, 2022, the entire contents of each are incorporated herein by reference.

### BACKGROUND

### Technical Field

The present disclosure relates to a method for manufacturing a magnetic core and a method for manufacturing a coil component.

### Background Art

Japanese Unexamined Patent Application Publication No. 2019-81918 describes a method for manufacturing a laminated soft magnetic body using an additive manufacturing machine which includes a means for supplying a raw material powder and a heating means capable of irradiating the raw material powder with a high-energy beam to melt it, and which can obtain a desired three-dimensional shaped product by repeating melting and solidification of the raw material powder in a chamber. The raw material powder is a soft magnetic powder composed of an iron alloy containing at least Al. The processing atmosphere in the chamber comprises nitrogen and/or oxygen. The method alternately repeats a first step of melting the soft magnetic powder with the heating means and then solidifying the melt to obtain a soft magnetic layer, and a second step of reheating the surface of the soft magnetic layer with the heating means in the above processing atmosphere to form an insulating layer of a nitride and/or an oxide on the surface of the soft magnetic layer, thereby obtaining a laminated soft magnetic body in which the soft magnetic layers and the insulating layers are formed alternately.

### SUMMARY

Japanese Unexamined Patent Application Publication No. 2019-81918 describes that the additive manufacturing machine is an apparatus which performs additive manufacturing (AM) using a metal powder, and may be an apparatus for performing powder bed fusion (PBF) or an apparatus for performing directed energy deposition (DED). The PBF method requires a metal powder supply system comprised of a feeder (powder supply tank), a recoater (metal powder spreading device), etc. On the other hand, the DED method requires a metal powder supply system comprised of a feeder (powder supply tank), a powder spray nozzle, etc. These supply systems are likely to cause a problem such as powder clogging, powder spreading defects, or spray pulsation due to a decrease in the fluidity of the metal powder. In such a case, a high-energy beam is applied to a metal powder which is being discontinuously supplied from a supply system, making it difficult to obtain a desired three-dimensional shaped product.

A method which involves preparing a metal powder with high sphericity and high monodispersibility, which is less likely to cause agglomeration, is conceivable as a method to prevent a decrease in the fluidity of metal powder in such a metal powder supply system. However, in order to obtain a metal powder with high sphericity and high monodispersibility, an extensive study is required to establish conditions for producing the metal powder e.g. by an atomization method and to adjust the particle size distribution of the metal powder e.g. by air flow classification. Therefore, it is difficult to obtain such a metal powder for three-dimensional metal forming. Examples of commercially available metal powders for three-dimensional metal forming, having high sphericity and high monodispersibility, include a metal powder for die forming, having the composition: Fe-18Ni-5Mo-9Co—AlTi, a metal powder for turbines and aircrafts, having the composition: Ni-20Cr-3Mo-5Nb—FeTiAl, and a metal powder for artificial bones, having the composition: Co-29Cr-6Mo (reference URL: http://www.sanyo-steel.co.jp/product/selected/selected13.php). However, for the soft magnetic metal powder as described in Japanese Unexamined Patent Application Publication No. 2019-81918, there are almost no examination cases of three-dimensional metal forming; therefore, it is difficult to obtain a soft magnetic metal powder with high sphericity and high monodispersibility.

As will be understood from the above, in a method for forming a three-dimensional shaped product using the soft magnetic metal powder as described in Japanese Unexamined Patent Application Publication No. 2019-81918, it is necessary to improve the fluidity of the soft magnetic metal powder in a metal powder supply system.

Therefore, the present disclosure provides a method for manufacturing a magnetic core which can prevent a decrease in the fluidity of a soft magnetic metal powder in a metal powder supply system. Also, the present disclosure provides a method for manufacturing a coil component which uses the magnetic core.

The method for manufacturing a magnetic core of the present disclosure comprises a step of melting a raw material powder, comprising a soft magnetic metal powder and an agglomeration inhibitor, using laser irradiation or electron beam sweeping, and then solidifying the melt, thereby forming a three-dimensional magnetic composite.

The method for manufacturing a coil component of the present disclosure comprises a step of manufacturing a magnetic core by the magnetic core manufacturing method of the present disclosure; and a step of winding a coil conductor around the peripheral surface of the magnetic core.

According to the present disclosure, it is possible to provide a method for manufacturing a magnetic core which can prevent a decrease in the fluidity of a soft magnetic metal powder in a metal powder supply system.

### BRIEF DESCRIPTION OF THE DRAWINGS

FIG. 1 is a diagram schematically showing soft magnetic metal powder and agglomeration inhibitor particles in a raw material powder in one embodiment of the present disclosure;

FIG. 2 is a diagram schematically showing a coil component manufactured according to an embodiment of the present disclosure; and

FIG. 3 shows SEM images of the interior of a magnetic core manufactured in Example 1-1.

### DETAILED DESCRIPTION

The magnetic core manufacturing method and coil manufacturing method of the present disclosure will now be described.

It is to be noted that the present disclosure is not limited to the embodiments described below, and various changes and modifications may be made thereto within the spirit and scope of the present disclosure. Two or more preferred features of the present disclosure as described below may be combined; such a combined feature will fall within the scope of the present disclosure.

### Magnetic Core Manufacturing Method

The magnetic core manufacturing method of the present disclosure comprises a step of melting a raw material powder, comprising a soft magnetic metal powder and an agglomeration inhibitor, using laser irradiation or electron beam sweeping, and then solidifying the melt, thereby forming a three-dimensional magnetic composite.

The magnetic core manufacturing method of the present disclosure, thanks to the inclusion of the agglomeration inhibitor in the raw material powder, can prevent agglomeration of the soft magnetic metal powder during supply of the raw material powder. This makes it possible to prevent a decrease in the fluidity of the soft magnetic metal powder in a metal powder supply system.

For a three-dimensional metal forming process to form a metal component for an aircraft or an automobile, or a mechanical component such as a molding die, studies are being made on the use of a metal powder with high sphericity and high monodispersibility to achieve good fluidity of the metal powder in a metal powder supply system. It is to be noted in this regard that in a three-dimensional shaped metal product for use as a mechanical component, an internal metal defect can cause a fatal failure. If an agglomeration inhibitor is used in the manufacturing of a three-dimensional shaped metal product for use as a mechanical component, there is a fear of metal destruction that may occur in an agglomeration inhibitor-derived portion of the formed mechanical component. Therefore, the use of an agglomeration inhibitor in three-dimensional metal forming is considered inappropriate for the manufacturing of a mechanical component. On the other hand, a magnetic core requires a lower mechanical strength than a mechanical component. Therefore, in the case of manufacturing a magnetic core as in the present disclosure, there is no need to consider the adverse mechanical effect produced by an agglomeration inhibitor.

In the magnetic core manufacturing method of the present disclosure, the three-dimensional magnetic composite may be manufactured by supplying the raw material powder, comprising a soft magnetic metal powder and an agglomeration inhibitor, onto a stage, then melting the raw material powder on the stage using laser irradiation or electron beam sweeping, and then solidifying the melt. Alternatively, in the magnetic core manufacturing method of the present disclosure, the three-dimensional magnetic composite may be manufactured by melting the raw material powder, comprising a soft magnetic metal powder and an agglomeration inhibitor, using laser irradiation or electron beam sweeping, and then solidifying the melt while the raw material powder is being supplied.

The magnetic core manufacturing method of the present disclosure may be performed, for example, by powder bed fusion (PBF) or by directed energy deposition (DED). The PBF method is a method for manufacturing a shaped product of a desired shape by repeating a step of allowing a high-energy beam (laser beam, electron beam, or the like) to scan a raw material powder along a predetermined path to melt the raw material powder, and then solidifying the melt every time a thin layer of the raw material powder (metal powder) is spread. The DED method is a method for manufacturing a shaped product of a desired shape by projecting a high-energy beam onto a raw material powder at a position around the focus of the beam to melt the raw material powder, and then solidifying the melt while scanning (moving) the melting/solidification position.

In the PBF method, the raw material powder is supplied by a supply system including a feeder (powder supply tank) and a recoater (metal powder spreading device). In the case of the DED method, the raw material powder is supplied by a supply system including a feeder (powder supply tank) and a powder spray nozzle.

In the magnetic core manufacturing method of the present disclosure, the raw material powder is prepared first.

The raw material powder comprises a soft magnetic metal powder and an agglomeration inhibitor. The including of the agglomeration inhibitor in the raw material powder can prevent agglomeration of the soft magnetic metal powder during supply of the raw material powder.

It is possible to use as the raw material powder a mixed powder composed of a mixture of a soft magnetic metal powder and a powdery agglomeration inhibitor, or a composite powder composed of a soft magnetic metal powder having on their surfaces a layer of an agglomeration inhibitor. For example, it is possible to use as the raw material powder a composite powder composed of a soft magnetic metal powder having on their surfaces a glass coating of an agglomeration inhibitor.

When a mixed powder composed of a mixture of a soft magnetic metal powder and a powdery agglomeration inhibitor is used as the raw material powder, the powdery agglomeration inhibitor may be fed, in the form of a mixture with the soft magnetic metal powder, to a supply system, e.g. to a feeder of the system. Alternatively, the powdery agglomeration inhibitor may be mixed with the soft magnetic metal powder in a supply system, e.g. in a feeder of the system.

### Soft Magnetic Metal Powder

The soft magnetic metal powder may be a crystalline metal powder or an amorphous metal powder.

Examples of the crystalline metal powder include an Fe—Si metal powder, an Fe—Ni metal powder, an Fe—Si—Al metal powder, an Fe—Si—Cr metal powder, a carbonyl iron powder, an Fe—Co metal powder, and an Fe—Co—V metal powder. The Fe—Ni metal powder may be a magnetic permalloy powder. The Fe—Si—Al metal powder may be a magnetic sendust powder. The Fe—Co metal powder may be permendur. The crystalline metal powder may be composed of a single type of powder or two or more types of powders.

Examples of the amorphous metal powder include an Fe—Si—B—Cr amorphous alloy powder and an Fe—B—Si amorphous alloy powder. The amorphous metal powder may be composed of a single type of powder or two or more types of powders.

The soft magnetic metal powder may be a mixed metal powder comprising two or more types of the crystalline metal powder and the amorphous metal powder.

The soft magnetic metal powder preferably contains at least one of Cr and Ni. When the soft magnetic metal powder contains at least one of Cr and Ni, a passive film, which is a thin oxide film, is formed on the surface of the soft magnetic metal in the three-dimensional magnetic composite product. The formation of the passivation film, which is a thin oxide film, on the surface of the soft magnetic metal in the three-dimensional magnetic composite product can improve the insulating properties of the magnetic composite.

While the particle size of the soft magnetic metal powder is not particularly limited, it is preferred that the minimum particle size of the soft magnetic metal powder be 9 μm or more, and the maximum particle size be 350 μm or less (i.e., a particle size of from 9 μm to 350 μm). When the minimum particle size of the soft magnetic metal powder is 9 μm or more, a three-dimensional magnetic composite can be formed with high precision. When the maximum particle size of the soft magnetic metal powder is 350 μm or less, the soft magnetic metal powder can be easily melted by laser irradiation or electron beam sweeping. For example, when the raw material powder is melted by laser irradiation in the PBF method, the soft magnetic metal powder preferably has a minimum particle size of 20 μm or more and a maximum particle size of 350 μm or less (i.e., a particle size from 20 μm to 350 μm). When the raw material powder is melted by electron beam sweeping in the PBF method, the soft magnetic metal powder preferably has a minimum particle size of 45 μm or more and a maximum particle size of 350 μm or less (i.e., a particle size from 45 μm to 350 μm).

When the raw material powder is melted by laser irradiation in the DED method, the soft magnetic metal powder preferably has a minimum particle size of 45 μm or more and a maximum particle size of 350 μm or less (i.e., a particle size from 45 μm to 350 μm). The minimum particle size and the maximum particle size of the soft magnetic metal powder refer to the minimum particle size and the maximum particle size, respectively, of the soft magnetic metal powder in the raw material powder.

While the average primary particle size of the soft magnetic metal powder is not particularly limited, it is preferably not less than 10 μm and not more than 300 μm (i.e., from 10 μm to 300 μm). The average primary particle size of the soft magnetic metal powder refers to a volume-based median diameter (D50) determined by a laser diffraction/scattering method. The average primary particle size of the soft magnetic metal powder refers to the average primary particle size of the soft magnetic metal powder in the raw material powder.

### Agglomeration Inhibitor

Any type of agglomeration inhibitor can be used as long as it can prevent agglomeration of the soft magnetic metal powder.

The agglomeration inhibitor preferably is agglomeration inhibitor particles having an average primary particle size smaller than that of the soft magnetic metal powder. The average primary particle size of the agglomeration inhibitor particles refers to a BET method-based average particle size, in particular an average particle size of the agglomeration inhibitor particles as calculated from the specific surface area determined by the BET method. When the BET method-based average particle size of the agglomeration inhibitor particles is smaller than the median diameter (D50) of the soft magnetic metal powder, then it can be said that the agglomeration inhibitor particles have an average primary particle size smaller than that of the soft magnetic metal powder. The average primary particle size of the agglomeration inhibitor particles refers to the average primary particle size of the agglomeration inhibitor particles in the raw material powder.

FIG. 1 is a diagram schematically showing the soft magnetic metal powder and the agglomeration inhibitor particles in the raw material powder in one embodiment of the present disclosure.

As shown in FIG. 1, when the agglomeration inhibitor is agglomeration inhibitor particles 2 having an average primary particle size smaller than that of the soft magnetic metal powder 1, the agglomeration inhibitor particles 2 enter between particles of the soft magnetic metal powder 1. The agglomeration inhibitor particles 2 between particles of the soft magnetic metal powder 1 electrostatically cling to the soft magnetic metal powder 1. The agglomeration inhibitor particles 2, clinging to the soft magnetic metal powder 1, improve the fluidity of the soft magnetic metal powder 1 by the bearing effect, and therefore can prevent a decrease in the fluidity of the soft magnetic metal powder 1.

The smaller the particle size of the agglomeration inhibitor particles, the more easily the agglomeration inhibitor particles electrostatically cling to the soft magnetic metal powder. On the other hand, if the particle size of the agglomeration inhibitor particles is too small, they are difficult to handle due to static electricity. As such, the average primary particle size of the agglomeration inhibitor particles is preferably not less than 5 nm and not more than 40 nm (i.e., from 5 nm to 40 nm).

The specific surface area (BET method) of the agglomeration inhibitor particles may be not less than 50 m²/g and not more than 400 m²/g (i.e., from 50 m²/g to 400 m²/g). The specific surface area of the agglomeration inhibitor particles refers to the specific surface area of the agglomeration inhibitor particles in the raw material powder.

The agglomeration inhibitor may be an inorganic lubricant or an organic lubricant. Only one type of agglomeration inhibitor may be used, or two or more types of agglomeration inhibitors may be used in combination. An agglomeration inhibitor composed of an inorganic lubricant may be used in combination with an agglomeration inhibitor composed of an organic lubricant.

The inorganic lubricant is, for example, an inorganic oxide such as silica (fumed silica, nanosilica, etc.), talc, or mica. The nanosilica is preferably monodisperse nanosilica. The inorganic lubricant may be composed of a single type of lubricant or two or more types of lubricants.

The organic lubricant is, for example, a metal soap such as a metal stearate (zinc stearate, calcium stearate, etc.). The organic lubricant may be composed of a single type of lubricant or two or more types of lubricants.

The agglomeration inhibitor is preferably composed of an insulating inorganic oxide. The use of an inorganic oxide having a low carbon content as an agglomeration inhibitor can avoid the generation of a volatile compound during the process of forming a three-dimensional magnetic composite, thereby facilitating the formation of the three-dimensional magnetic composite. Further, when an insulating inorganic oxide is used as an agglomeration inhibitor, the insulating material is interposed between the soft magnetic metal particles in the three-dimensional magnetic composite product. The insulating agglomeration inhibitor, interposed between the soft magnetic metal particles, can itself inhibit conductivity. This reduces the eddy current loss and the magnetic loss in the magnetic composite and improves the DC superposition characteristics of the magnetic composite.

The agglomeration inhibitor particles are preferably silica particles having an average primary particle size of not less than 5 nm and not more than 40 nm (i.e., from 5 nm to 40 nm), and more preferably are fumed silica particles having an average primary particle size of not less than 5 nm and not more than 40 nm (i.e., from 5 nm to 40 nm). The average primary particle size of silica particles may be not less than 7 nm and not more than 40 nm (i.e., from 7 nm to 40 nm). The use of the agglomeration inhibitor particles having an average primary particle size of not less than 5 nm and not more than 40 nm (i.e., from 5 nm to 40 nm) can further prevent a decrease in the fluidity of the soft magnetic metal powder. In addition, since the silica particles themselves have insulating properties, it becomes possible to reduce the eddy current loss and the magnetic loss in the magnetic composite and improve the DC superposition characteristics of the magnetic composite.

In other words, the agglomeration inhibitor particles are preferably silica particles having a specific surface area (BET method) of not less than 50 m²/g and not more than 400 m²/g (i.e., from 50 m²/g to 400 m²/g), and more preferably are fumed silica particles having a specific surface area (BET method) of not less than 50 m²/g and not more than 400 m²/g (i.e., from 50 m²/g to 400 m²/g).

There is no particular limitation on the amount of the agglomeration inhibitor; it may be not less than 0.1 vol. % and not more than 1.0 vol. % (i.e., from 0.1 vol. % to 1.0 vol. %), not less than 0.1 vol. % and not more than 0.8 vol. % (i.e., from 0.1 vol. % to 0.8 vol. %), not less than 0.1 vol. % and not more than 0.6 vol. % (i.e., from 0.1 vol. % to 0.6 vol. %), or not less than 0.1 vol. % and not more than 0.5 vol. % (i.e., from 0.1 vol. % to 0.5 vol. %) based on the total amount of the soft magnetic metal powder and the agglomeration inhibitor. When the amount of the agglomeration inhibitor is not less than 0.1 vol. % based on the total amount of the soft magnetic metal powder and the agglomeration inhibitor, a decrease in the fluidity of the soft magnetic metal powder can be further prevented.

In the raw material powder, at least part of the surfaces of the soft magnetic metal powder are preferably covered with the agglomeration inhibitor. For example, in FIG. 1, some of the agglomeration inhibitor particles 2 as an agglomeration inhibitor are in contact with the surfaces of the soft magnetic metal powder 1. When at least part of the agglomeration inhibitor is in contact with the surfaces of the soft magnetic metal powder 1 in this way, it can be said that at least part of the surfaces of the soft magnetic metal powder 1 are covered with the agglomeration inhibitor.

When at least part of the surfaces of the soft magnetic metal powder are covered with the agglomeration inhibitor in the raw material powder, the agglomeration inhibitor will be scattered in the soft magnetic metal in the three-dimensional magnetic composite product. Thus, when the agglomeration inhibitor is an insulator, the insulator will be scattered in the soft magnetic metal in the magnetic composite. This further reduces the eddy current loss and the magnetic loss in the magnetic composite and further improves the DC superposition characteristics of the magnetic composite.

### Insulating Material

The raw material powder preferably further contains an insulating material.

When the raw material powder contains an insulating material, an insulator derived from the insulating material is to be scattered in the three-dimensional magnetic composite product. This reduces the eddy current loss and the magnetic loss in the magnetic composite and improves the DC superposition characteristics of the magnetic composite.

In the raw material powder, an insulating layer comprising an insulating material may be provided on the surfaces of the soft magnetic metal powder. When the soft magnetic metal powder has such an insulating surface layer comprising an insulating material, the insulating layer melts together with the soft magnetic metal powder during manufacturing of a magnetic composite, which will result in the formation of a magnetic composite in which the soft magnetic metal is covered with an insulator. This reduces the eddy current loss and the magnetic loss in the magnetic composite and improves the DC superposition characteristics of the magnetic composite.

For example, an insulating layer, comprising an insulating material composed mainly of P or Si, may be provided on the surfaces of the soft magnetic metal powder, which may be a crystalline metal powder or an amorphous metal powder, so that the raw material powder contains the insulating material. Examples of the insulating material composed mainly of P or Si include fused silica, phosphate glass, borosilicate glass, and silicate glass.

Alternatively, an insulating layer, comprising an insulating material such as alumina or ferrite (e.g., Ni—Zn ferrite, Mn—Zn ferrite, or magnetite), may be provided on the surfaces of the soft magnetic metal powder, which may be a crystalline metal powder or an amorphous metal powder, so that the raw material powder contains the insulating material.

A soft magnetic metal powder having an insulating surface layer comprising an insulating material may be used in combination with a soft magnetic metal powder having no insulating surface layer comprising an insulating material. In other words, the raw material powder may contain both a soft magnetic metal powder having an insulating surface layer comprising an insulating material and a soft magnetic metal powder having no insulating surface layer comprising an insulating material.

The insulating material may be added, as a powder separate from the soft magnetic metal powder, to the raw material powder.

When the insulating material is added as a powder separate from the soft magnetic metal powder, examples of the insulating material powder include a fused silica powder, a phosphate glass powder, a borosilicate glass powder, a silicate glass powder, an alumina powder, and a ferrite (e.g., Ni—Zn ferrite, Mn—Zn ferrite, or magnetite) powder.

The insulating material is preferably a ceramic powder comprising silicon dioxide as a base material. When the insulating material is a ceramic powder comprising silicon dioxide as a base material, the ceramic powder separates the magnetic metal portion in the magnetic composite. This prevents passage of a high eddy current and provides a magnetic flux gap in the magnetic composite, resulting in a reduction in the magnetic loss of the magnetic composite and an enhancement in the DC superposition characteristics of the magnetic composite. Therefore, when the magnetic composite is used as a coil core, the eddy current loss and the magnetic loss in the magnetic composite are further reduced and the DC superposition characteristics of the magnetic composite are further improved.

The ceramic powder comprising silicon dioxide as a base material is, for example, a ceramic powder comprising fused silica, borosilicate glass, or silicate glass as a main component.

When the insulating material is added as a powder separate from the soft magnetic metal powder, the average primary particle size of the insulating material is not particularly limited; it may be not less than 0.1 μm and not more than 10 μm (i.e., from 0.1 μm to 10 μm). The average primary particle size of the insulating material refers to a volume-based median diameter (D50) determined by a laser diffraction/scattering method. The average primary particle size of the insulating material refers to the average primary particle size of the insulating material in the raw material powder.

The amount of the insulating material may be not less than 1.0 vol. % and not more than 30.0 vol. % (i.e., from 1.0 vol. % to 30.0 vol. %) based on the total amount of the soft magnetic metal powder, the agglomeration inhibitor, and the insulating material. When the amount of the insulating material is not less than 1.0 vol. % based on the total amount of the soft magnetic metal powder, the agglomeration inhibitor, and the insulating material, the content of the insulating material in the magnetic composite can be made high. This further reduces the eddy current loss and the magnetic loss in the magnetic composite and further improves the DC superposition characteristics of the magnetic composite. When the amount of the insulating material is not more than 30.0 vol. % based on the total amount of the soft magnetic metal powder, the agglomeration inhibitor, and the insulating material, the raw material powder particles are easily melted and bonded to each other by laser irradiation or electron beam sweeping, so that a three-dimensional magnetic composite can be manufactured well.

In the magnetic core manufacturing method of the present disclosure, the raw material powder is melted by laser irradiation or electron beam sweeping, and then the melt is solidified to form a three-dimensional magnetic composite.

While there is no particular limitation on the atmosphere in which the magnetic composite is formed, the magnetic composite is preferably formed in a low-oxygen atmosphere such as a nitrogen atmosphere. By forming the magnetic composite in a low-oxygen atmosphere, it is possible to prevent oxidation of the soft magnetic metal powder upon melting of the raw material powder, thereby preventing a failure to obtain a magnetic core having desired magnetic properties. Further, by adjusting the oxygen concentration of the atmosphere, in which the magnetic composite is manufactured, to a low level, an oxide layer, and thus an insulating layer, can be formed at the metal interfaces (interfaces formed by fusion of the soft magnetic metal powder) of the magnetic composite. This contributes to a reduction in the magnetic loss and an improvement in the DC superposition characteristics. For example, when a magnetic composite is formed using a soft magnetic metal powder containing at least one of Cr and Ni as described above, a passive film, which is an oxide layer, will be formed in the three-dimensional magnetic composite product by adjusting the oxygen concentration of the atmosphere, in which the magnetic composite is formed, to a low level.

In the present disclosure, a three-dimensional magnetic composite of a desired shape can be formed by moving the irradiation position of a laser or electron beam along a desired trajectory. The shape of the magnetic composite, formed in the magnetic composite forming step, is not particularly limited. For example, a ring-shaped magnetic composite may be formed in the magnetic composite forming step. Alternatively, a rod-shaped, cylindrical, or rectangular parallelepiped magnetic composite may be formed in the magnetic composite forming step.

In the method for manufacturing a laminated soft magnetic body, described in Japanese Unexamined Patent Application Publication No. 2019-81918, soft magnetic layers and insulating layers, which are produced by oxidizing the soft magnetic layers, are alternately formed on top of each other. Such a method cannot manufacture a ring-shaped magnetic core with an insulating layer provided in a direction which separates an eddy current. Therefore, in order to obtain a ring-shaped magnetic core, it is necessary to bend the laminated soft magnetic body into a ring shape, or to cut four pieces from the laminated soft magnetic body, and bond the pieces together. In addition, the magnetic bodies or the insulators intersect each other at right angles at the joints of the manufactured ring-shaped magnetic core. Magnetic flux cutting may occur in such portions.

In contrast, the magnetic core manufacturing method of the present disclosure does not require the alternate formation of soft magnetic layers and insulating layers; a ring-shaped magnetic composite product can be used as it is as a ring-shaped magnetic core.

According to the magnetic core manufacturing method of the present disclosure, a magnetic core without a connection between magnetic cores can be manufactured. A magnetic core having such a structure, because of no magnetic gap, has excellent magnetic properties. According to the magnetic core manufacturing method of the present disclosure, a ring-shaped magnetic core with no magnetic gap in the circumferential direction of the ring can be easily manufactured. Thus, it is possible to manufacture a ring-shaped magnetic core which is free of a leakage flux from a magnetic gap and which has excellent magnetic properties.

### Coil Component Manufacturing Method

The coil component manufacturing method of the present disclosure comprises: a step of manufacturing a magnetic core by the magnetic core manufacturing method of the present disclosure; and a step of winding a coil conductor around the peripheral surface of the magnetic core.

According to the magnetic core manufacturing method of the present disclosure, a magnetic core having a high resistance and high magnetic properties can be obtained in any desired shape and size. Therefore, the coil component manufacturing method of the present disclosure does not require a magnetic core forming step using an ultrahigh-pressure press-forming machine and a dedicated mold. Therefore, the coil component manufacturing method of the present disclosure can manufacture a coil component in a short time and at low cost.

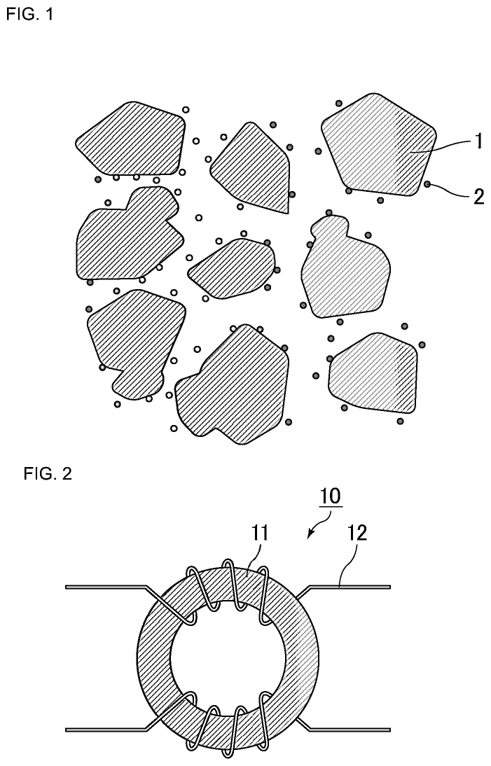

FIG. 2 is a diagram schematically showing a coil component manufactured according to an embodiment of the present disclosure.

In the coil component 10, a coil conductor 12 is wound around a magnetic core 11 manufactured by the magnetic core manufacturing method of the present disclosure.

The magnetic core 11 is ring-shaped in FIG. 2. The shape of the magnetic core 11 is not particularly limited and may be, for example, a rod shape, a cylindrical shape, or a rectangular parallelepiped shape.

In FIG. 2, two coil conductors 12 are wound around the magnetic core 11. One or more coil conductors 12 may be wound around the magnetic core 11. The number of turns of each coil conductor 12 on the magnetic core 11 is not particularly limited.

### EXAMPLES

The following examples disclose the magnetic core manufacturing method of the present disclosure in greater detail. It is to be noted that the present disclosure is not limited only to the examples.

### Example 1

The soft magnetic metal powder, the agglomeration inhibitor and the insulating material, shown in Table 1 below, were mixed to prepare a raw material powder.

The fumed silica, used as an agglomeration inhibitor, is agglomeration inhibitor particles, and was used in an amount of 0.2 vol. % based on the volumetric amount of the raw material powder.

The fused silica, used as an insulating material, was used in an amount of 1.3 vol. % based on the volumetric amount of the raw material powder.

When phosphate glass was used as an insulating material, an insulating layer of phosphate glass having a thickness of about 15 nm was provided on the surfaces of the soft magnetic metal powder.

The raw material powder thus prepared was put into the feeder (powder supply tank) of a DED-type metal 3D printer LAMDA200 [manufactured by Nidec Machine Tool Corporation]. In a nitrogen gas flow atmosphere, the raw material powder was melted using laser irradiation, and then the melt was solidified to form a ring-shaped magnetic core on a SUS steel plate. The outer diameter of the ring-shaped magnetic core was 16 mm, and the inner diameter of the ring-shaped magnetic core was 10 mm.

The laser irradiation was performed under the conditions of: an initial laser output of not less than 200 W and not more than 1200 W (i.e., from 200 W to 1200 W), a scanning speed of 800 mm/min, and a spot diameter of 2 mm.

TABLE 1

| | Soft magnetic metal powder | | | | | |
|---|---|---|---|---|---|---|
| | Crystalline | Amorphous metal | Agglomeration | | | |
| | metal powder | powder | inhibitor | Insulating material | | Fluidity |
| Ex. 1- | Fe-3 Si | — | Fumed silica | — | — | ○ |
| 1 | powder | | (aps 12 nm, | | | |
| | (D50 41 μm) | | ssa 200 m²/g) | | | |
| Ex. 1- | — | Fe—Si—Cr powder | Fumed silica | Phosphate | — | ○ |
| 2 | | [containing P, B and | (aps 12 nm, | glass | | |
| | | Mn] | ssa 200 m²/g) | coating | | |
| | | (D50 23 μm, D10 9 | | | | |
| | | μm, D90 50 μm) | | | | |
| Ex. 1- | Fe-3 Si | — | Fumed silica | — | Fused silica | ○ |
| 3 | powder | | (aps 12 nm, | | powder | |
| | (D50 41 μm) | | ssa 200 m²/g) | | (D50 0.59 | |
| | | | | | μm, | |
| | | | | | ssa 6.1 | |
| | | | | | m²/g) | |
| Ex. 1- | Fe-3 Si | — | Fumed silica | — | Fused silica | ○ |
| 4 | powder | | (aps 12 nm, | | powder | |
| | (D50 41 μm) | | ssa 200 m²/g) | | (D50 5.1 | |
| | | | | | μm, | |
| | | | | | ssa 1.6 | |
| | | | | | m²/g) | |
| Comp. | Fe-3 Si | — | — | — | Fused silica | x |
| Ex. | powder | | | | powder | |
| 1-1 | (D50 41 μm) | | | | (D50 0.59 | |
| | | | | | μm, | |
| | | | | | ssa 6.1 | |
| | | | | | m²/g) | |
| Comp. | — | Fe—Si—Cr powder | — | Phosphate | Fused silica | x |
| Ex. | | [containing P, B and | | glass | powder | |
| 1-2 | | Mn] | | coating | (D50 0.59 | |
| | | (D50 23 μm, D10 9 | | | μm, | |
| | | μm, D90 50 μm) | | | ssa 6.1 | |
| | | | | | m²/g) | |
| Comp. | — | Fe—Si—Cr powder | — | Phosphate | Fused silica | x |
| Ex. | | [containing P, B and | | glass | powder | |
| 1-3 | | Mn] | | coating | (D50 5.1 | |
| | | (D50 23 μm, D10 9 | | | μm, | |
| | | μm, D90 50 μm) | | | ssa 1.6 | |
| | | | | | m²/g) | |

The fluidity of the raw material powder during the process of manufacturing a magnetic core was evaluated. The evaluation criteria are as follows.

O (Good): No agglomeration of the raw material powder was visually observed in the feeder of the metal 3D printer.

X (Bad): Agglomeration of the raw material powder was visually observed in the feeder of the metal 3D printer.

In Comparative Examples 1-1 to 1-3 in which the respective raw material powders contain no agglomeration inhibitor, agglomeration of the respective raw material powders was visually observed in the feeder. In each of Comparative Examples 1-1 to 1-3, clogging of the raw material powder occurred in the feeder during the process of manufacturing a magnetic core, so that a magnetic core could not be manufactured.

In Examples 1-1 to 1-4 in which the respective raw material powders contain the agglomeration inhibitor, agglomeration of the respective raw material powders was not observed in the feeder. In each of Examples 1-1 to 1-4, a decrease in the fluidity of the soft magnetic metal powder was prevented in the metal powder supply system, so that a magnetic core of a desired shape could be manufactured.

The ring-shaped magnetic core produced in Example 1-1 was cut off from the SUS steel plate by electro-discharge machining. The interior of the ring-shaped magnetic core was observed with a scanning electron microscope (SEM).

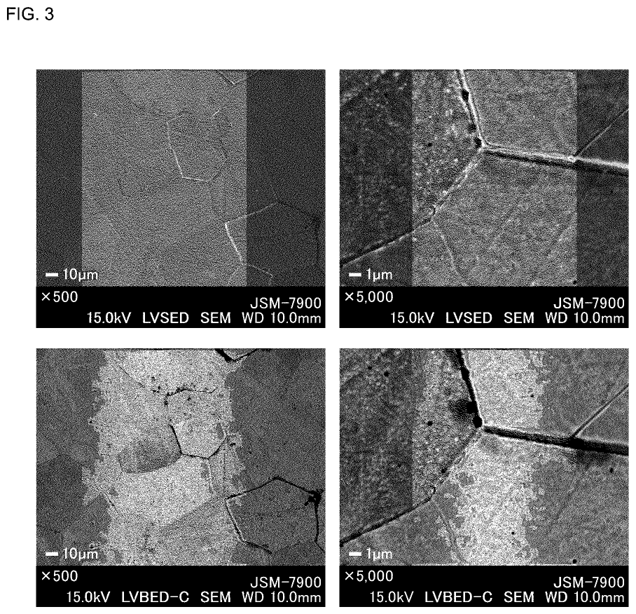

FIG. 3 shows SEM images of the interior of the magnetic core manufactured in Example 1-1.

In the SEM images of FIG. 3, metal particles having a relatively small particle size on the order of tens of μm were observed in the interior of the manufactured magnetic core. In the present disclosure, the particle size of metal particles in the interior of a magnetic core product can be controlled by adjusting conditions such as the output and scanning speed of laser irradiation or electron beam sweeping.

### Example 2

Ring-shaped magnetic cores were manufactured under the same conditions as in Example 1 except that the composition of the raw material powder was changed as shown in Table 2.

TABLE 2

| | Composition of raw material powder | | |
|---|---|---|---|
| | Soft Magnetic metal | Agglomeration | |
| | powder | inhibitor | |
| | (vol. %) | (vol. %) | |
| | Fe-3 Si powder | Fumed silica | Fluidity |
| Example 2-1 | 99.9 | 0.1 | ◯ |
| Example 2-2 | 99.8 | 0.2 | ◯ |
| Example 2-3 | 99.7 | 0.3 | ◯ |
| Example 2-4 | 99.5 | 0.5 | ◯ |
| Example 2-5 | 99.0 | 1.0 | ◯ |

The fluidity of the raw material powder during the process of manufacturing a magnetic core was evaluated in the same manner as in Example 1.

In Examples 2-1 to 2-5 in which the amount of the agglomeration inhibitor was not less than 0.1 vol. % and not more than 1.0 vol. % (i.e., from 0.1 vol. % to 1.0 vol. %) based on the total amount of the soft magnetic metal powder and the agglomeration inhibitor, agglomeration of the respective raw material powders was not observed in the feeder. In each of Examples 2-1 to 2-5, a decrease in the fluidity of the soft magnetic metal powder was prevented in the metal powder supply system, so that a magnetic core of a desired shape could be manufactured.

### Example 3

Ring-shaped magnetic cores were manufactured under the same conditions as in Example 1 except that the composition of the raw material powder was changed as shown in Table 3. The fused silica powder used was a fused silica powder having a D50 diameter of 0.59 μm.

TABLE 3

| | Composition of raw material powder | | | | |
|---|---|---|---|---|---|
| | | | | Insulating | |
| | Soft magnetic metal | | Agglomeration | material | |
| | powder (vol. %) | | inhibitor | (vol. %) | |
| | Fe-3 Si | Fe—Si—Cr | (vol. %) | Fused silica | |
| | powder | powder | Fumed silica | powder | Fluidity |
| Example 3-1 | 98.5 | — | 0.2 | 1.3 | ◯ |
| Example 3-2 | 94.8 | — | 0.2 | 5.0 | ◯ |
| Example 3-3 | — | 98.5 | 0.2 | 1.3 | ◯ |
| Example 3-4 | — | 94.6 | 0.4 | 5.0 | ◯ |

The fluidity of the raw material powder during the process of manufacturing a magnetic core was evaluated in the same manner as in Example 1.

In Examples 3-1 to 3-4 in which the amount of the insulating material was 1.3 vol. % or 5.0 vol. % based on the total amount of the soft magnetic metal powder, the agglomeration inhibitor, and the insulating material, agglomeration of the respective raw material powders was not observed in the feeder. In each of Examples 3-1 to 3-4, a decrease in the fluidity of the soft magnetic metal powder was prevented in the metal powder supply system, so that a magnetic core of a desired shape could be manufactured. Further, in Examples 3-1 to 3-4 in which the amount of the agglomeration inhibitor was not less than 0.1 vol. % and not more than 1.0 vol. % (i.e., from than 0.1 vol. % to 1.0 vol. %) based on the total amount of the soft magnetic metal powder and the agglomeration inhibitor, a decrease in the fluidity of the soft magnetic metal powder was prevented in the metal powder supply system.

A requisite amount of an agglomeration inhibitor will now be considered with a specific example. Consider, as an exemplary raw material powder containing fused silica having a larger specific area than a soft magnetic metal powder, a raw material powder containing the soft magnetic metal powder and the fused silica, both used in the examples, in an amount of 95 vol. % and 5 vol. %, respectively, based on the total amount of the soft magnetic metal powder and the fused silica. The overall specific surface area of the soft magnetic metal powder and the fused silica can be calculated to be 0.12 m²/g. When fumed silica (specific surface area 0.29 m²/g) is contained in the raw material powder in an amount of 0.5 vol. % based on the total amount of the soft magnetic metal powder and the fumed silica, the fumed silica can cover the surfaces of the soft magnetic metal powder. It appears in this regard that if the surface area of the fumed silica is at least at a level equivalent to the specific surface area of the soft magnetic metal powder and the fused silica, then a decrease in the fluidity of the soft magnetic metal powder can be prevented. It is, therefore, conceivable that fumed silica is fully expected to achieve the effect of preventing a decrease in the fluidity of the soft magnetic metal powder as long as the fumed silica is contained in an amount of about 0.5 vol. % based on the total amount of the soft magnetic metal powder and the fumed silica.

What is claimed is:

1. A method for manufacturing a magnetic core, comprising:
melting a raw material powder, comprising a soft magnetic metal powder and an agglomeration inhibitor, using laser irradiation or electron beam sweeping, to create a melt; and
then solidifying the melt to form a three-dimensional magnetic composite.

2. The method for manufacturing a magnetic core according to claim 1, wherein the agglomeration inhibitor is agglomeration inhibitor particles having an average primary particle size smaller than that of the soft magnetic metal powder.

3. The method for manufacturing a magnetic core according to claim 1, wherein the agglomeration inhibitor includes an insulating inorganic oxide.

4. The method for manufacturing a magnetic core according to claim 2, wherein the agglomeration inhibitor particles are silica particles having an average primary particle size of from 5 nm to 40 nm.

5. The method for manufacturing a magnetic core according to claim 1, wherein an amount of the agglomeration inhibitor is from 0.1 vol. % to 1.0 vol. % based on a total amount of the soft magnetic metal powder and the agglomeration inhibitor.

6. The method for manufacturing a magnetic core according to claim 1, wherein in the raw material powder, at least part of surfaces of the soft magnetic metal powder are covered with the agglomeration inhibitor.

7. The method for manufacturing a magnetic core according to claim 1, wherein
the soft magnetic metal powder is at least one crystalline metal powder selected from the group consisting of an Fe—Si metal powder, an Fe—Ni metal powder, an Fe—Si—Al metal powder, an Fe—Si—Cr metal powder, a carbonyl iron powder, an Fe-Co metal powder, and an Fe—Co—V metal powder; or
at least one amorphous metal powder selected from the group consisting of an Fe—Si—B—Cr amorphous alloy powder and an Fe—B—Si amorphous alloy powder; or a mixed metal powder comprising two or more of the crystalline metal powders and the amorphous metal powders.

8. The method for manufacturing a magnetic core according to claim 1, wherein the raw material powder further comprises an insulating material.

9. The method for manufacturing a magnetic core according to claim 8, wherein an insulating layer comprising the insulating material is on surfaces of the soft magnetic metal powder.

10. The method for manufacturing a magnetic core according to claim 8, wherein the insulating material is a ceramic powder comprising silicon dioxide as a base material.

11. The method for manufacturing a magnetic core according to claim 8, wherein an amount of the insulating material is from 1.0 vol. % to 30.0 vol. % based on a total amount of the soft magnetic metal powder, the agglomeration inhibitor, and the insulating material.

12. The method for manufacturing a magnetic core according to claim 1, wherein a ring-shaped magnetic composite is formed in the solidifying to form the three-dimensional magnetic composite.

13. A method for manufacturing a coil component, comprising:
manufacturing a magnetic core by the manufacturing method according to claim 1; and
winding a coil conductor around a peripheral surface of the magnetic core.

14. The method for manufacturing a magnetic core according to claim 2, wherein the agglomeration inhibitor includes an insulating inorganic oxide.

15. The method for manufacturing a magnetic core according to claim 2, wherein an amount of the agglomeration inhibitor is from 0.1 vol. % to 1.0 vol. % based on a total amount of the soft magnetic metal powder and the agglomeration inhibitor.

16. The method for manufacturing a magnetic core according to claim 2, wherein in the raw material powder, at least part of surfaces of the soft magnetic metal powder are covered with the agglomeration inhibitor.

17. The method for manufacturing a magnetic core according to claim 2, wherein
the soft magnetic metal powder is at least one crystalline metal powder selected from the group consisting of an Fe—Si metal powder, an Fe—Ni metal powder, an Fe—Si—Al metal powder, an Fe—Si—Cr metal powder, a carbonyl iron powder, an Fe—Co metal powder, and an Fe—Co—V metal powder; or
at least one amorphous metal powder selected from the group consisting of an Fe—Si—B—Cr amorphous alloy powder and an Fe—B—Si amorphous alloy powder; or a mixed metal powder comprising two or more of the crystalline metal powders and the amorphous metal powders.

18. The method for manufacturing a magnetic core according to claim 2, wherein
the raw material powder further comprises an insulating material.

19. The method for manufacturing a magnetic core according to claim 9, wherein
an amount of the insulating material is from 1.0 vol. % to 30.0 vol. % based on a total amount of the soft magnetic metal powder, the agglomeration inhibitor, and the insulating material.

20. The method for manufacturing a magnetic core according to claim 2, wherein
a ring-shaped magnetic composite is formed in the solidifying to form the three-dimensional magnetic composite.
